(19) United States
(12) Patent Application Publication
(10) Pub. No.: US 2016/0370654 A1
(43) Pub. Date: Dec. 22, 2016

(54) Display Panel and Display Device

(71) Applicant: BOE TECHNOLOGY GROUP CO., LTD, Beijing (CN)

(72) Inventors: Jaegeon You, Beijing (CN); Xinxing Wang, Beijing (CN); Weili Zhao, Beijing (CN); Guangkui Qin, Beijing (CN)

(73) Assignee: BOE Technology Group Co., Ltd., Beijing (CN)

(21) Appl. No.: 14/907,672

(22) PCT Filed: May 14, 2015
(86) PCT No.: PCT/CN2015/079004

§ 371 Date: Jan. 26, 2016

(30) Foreign Application Priority Data
Jan. 7, 2015 (CN) 201510041421.3

(51) Int. Cl. G02F 1/1335; G02F 1/1333

(52) U.S. Cl. CPC G02F 1/133611; G02F 1/133608; G02F 1/133308

(57) ABSTRACT

A display panel and a display device are provided. The display panel comprises a central region and peripheral regions. The peripheral regions are provided at two opposite ends of the display panel and have a first curvature; the central region is provided between the two opposite ends of the display panel and has a second curvature; and the second curvature of the central region is smaller than the first curvature of the peripheral regions.

### TECHNICAL FIELD

Embodiments of the present disclosure relate to a display panel and a display device.

### BACKGROUND

Currently, modes of liquid display panel mainly include a Twisted Nematic (TN) mode, a Vertical Alignment (VA) mode, an In-Plane Switching (IPS) mode, an Advanced Super Dimension Switch (ADS) mode and the like. The ADS mode can improve image quality of the liquid crystal display panel, and draws more and more public attention and interest due to merits such as high resolution, high transmittance, low power consumption, wide viewing angle, high aperture ratio, low chromatic aberration, no push Mura and the like.

At present, a curve surface display technology is widely applied in large-screen televisions and high-end televisions. With developments of the curve surface display technology, liquid crystal display panel with the curved display surface is increasingly popular with people and people begin to pay attention to its display effect. In the liquid crystal display panel in which initial alignment of liquid crystal molecules is in a horizontal direction (e.g., ADS mode or IPS mode liquid crystal display panel, etc.), in the case that a curve degree of peripheral regions on two ends of the display panel is same as a curve degree of a central region of the display panel (in this case, the display panel is called as an O-shape display panel for simplicity), optical axis deviation generates between upper and lower substrates and further leads to serious light leakage problems at edges of the display panel due to different bending stresses applied on upper and lower substrates of the display panel (for example, the upper substrate is compressed, and the lower substrate is stretched).

### SUMMARY

An embodiment of the present disclosure provides a display panel, The display panel comprises a central region and peripheral regions. The peripheral regions are provided at two opposite ends of the display panel and have a first curvature; the central region is provided between the two opposite ends of the display panel and has a second curvature; and the second curvature of the central region is smaller than the first curvature of the peripheral regions.

For example, the two opposite ends of the display panel respectively bend toward a front side of the display panel with respect to a center of the display panel.

For example, the two opposite ends are two opposite ends respectively provided on left and right sides of the display panel.

For example, the peripheral regions are respectively provided on left and right sides of the central region and are symmetrical to each other.

For example, the peripheral regions have a same first curvature.

For example, a radius of curvature of the peripheral region is within a range of 1000 mm-7000 mm.

For example, a radius of curvature of the central region is within a range of 7000 mm-15000 mm.

An embodiment of the present disclosure provides a display device. The display device comprises a display panel as described above and a backlight module disposed on a side of the display panel away from a display surface.

For example, the backlight module has a same curved shape as the display panel.

For example, the display panel and the backlight module are fixedly connected with each other by engagement components; or, the display panel and the backlight module are connected with each other by an adhesive; or, the display panel and the backlight module are fixedly connected with each other by a magnetic force or a frame.

### BRIEF DESCRIPTION OF THE DRAWINGS

In order to clearly illustrate the technical solution of the embodiments of the disclosure, the drawings of the embodiments will be briefly described in the following; it is obvious that the described drawings are only related to some embodiments of the disclosure and thus are not limitative of the disclosure.

FIG. 1 is a schematic view I illustrating a curved shape of a display panel according to an embodiment of the disclosure;

FIG. 2 is a schematic view II illustrating the curved shape of the display panel according to the embodiment of the disclosure;

FIG. 3 is a schematic view illustrating the curved shape of the display panel according to the embodiment of the disclosure and the curved shapes of comparative display panels;

FIG. 4a to FIG. 4c are respectively schematic views illustrating light leakage phenomena in the case that the display panel according to the embodiment of the disclosure and the comparative display panels perform curve surface display; and

FIG. 5a to FIG. 5c are respectively schematic views illustrating black matrix deviations in the case that the display panel according to the embodiment of the disclosure and the comparative display panels perform curve surface display.

### DETAILED DESCRIPTION

In order to make objects, technical details and advantages of the embodiments of the invention apparent, the technical solutions of the embodiments will be described in a clearly and fully understandable way in connection with the drawings related to the embodiments of the invention. Apparently, the described embodiments are just a part but not all of the embodiments of the invention. Based on the described embodiments herein, those skilled in the art can obtain other embodiment(s), without any inventive work, which should be within the scope of the invention.

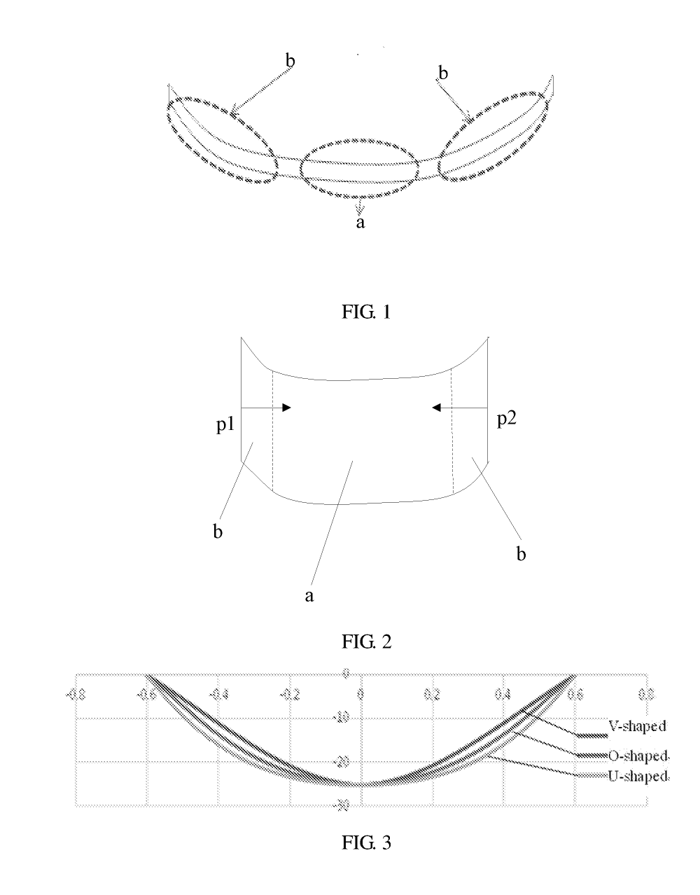

An embodiment of the present disclosure provides a display panel; as shown in FIG. 1, the display panel for example comprises a central region a and peripheral regions b. The peripheral regions b are provided at two opposite ends of the display panel and have a first curvature; the central region a is provided between the two opposite ends of the display panel and has a second curvature, and the second curvature of the central region a is smaller than the first curvature of the peripheral regions b. For example, the two opposite ends of the display panel are provided along a horizontal direction.

The curve degree of the central region a of the display panel is smaller than that of the peripheral regions b of the display panel; in this case, the display panel is called as a U-shape display panel for simplicity. Compared with the comparative display panel in which the curve degree of the central region a is same as that of the peripheral regions b (such comparative display panel is called as O-shape display panel for simplicity), in the case that the display panel according to the embodiment of the present disclosure performs curve surface display under the mode in which initial alignment of the liquid crystal molecules is in a horizontal direction, upper and lower substrates of the display panel, being applied by different bending stresses, have less optical axis deviations therebetween, and thus light leakage problem at edges of the display panel at the time of curve surface display is reduced.

For example, in the above display panel according to the embodiment of the present disclosure, as shown in FIG. 2, in order to achieve curve surface display of the display panel, two opposite ends p1 and p2 respectively provided on left and right sides of the display panel bend toward a front side of the display panel with respect to a center of the display panel, that is, two opposite ends p1 and p2 respectively provided on left and right sides of the display panel bend along directions indicated by arrows in FIG. 2. As shown in FIG. 2, two opposite ends p1 and p2 bend along the directions pointing to the central region a of the display panel, so that the two opposite ends form two peripheral regions b with respect to the central region a and the display panel in curved shape is obtained. Thus, the display panel in curved shape is applicable to a curve display device so as to achieve curve surface display.

For example, in the above display panel according to the embodiment of the present disclosure, as shown in FIG. 1 and FIG. 2, the display panel comprises the two peripheral regions b, and the two peripheral regions b are respectively provided on left and right sides of the central region a and are symmetrical to each other. For example, the two peripheral regions b have a same first curvature, that is, the two peripheral regions b have a same curve degree, and thus, the two peripheral regions b of the display panel endure a same stress, which facilitates the display panel to have a force balance between left and right ends to remain a curved shape, avoids a dislocation problem of upper and lower substrates of the display panel due to uneven forces on the two opposite ends, and further avoids a degradation of display effect due to the dislocation problem of the upper and lower substrates of the display panel.

In the above display panel according to the embodiment of the present disclosure, the second curvature of the central region a of the display panel is smaller than the first curvature of the peripheral regions b. For example, a radius of curvature of the peripheral regions b is within a range of 1000 mm-7000 mm, and a radius of curvature of the central region a is within a range of 7000 mm-15000 mm; in this case, the curve degree of the central region a is smaller than that of the peripheral regions b. Compared with the comparative display panel in which the curve degree of the central region a is same as that of the peripheral regions b (such comparative display panel is called as O-shape display panel for simplicity), in the case that the display panel according to the embodiment of the present disclosure performs curve surface display under the mode in which initial alignment of the liquid crystal molecules is in a horizontal direction, upper and lower substrates of the display panel, being applied by different bending stresses, have less optical axis deviations therebetween, and thus light leakage problem at edges of the display panel at the time of curve surface display can be reduced.

An embodiment of the present disclosure provides a display device. For example, the display device comprises the above display panel according to the embodiment of the present disclosure, and a backlight module disposed on a side of the display panel away from the display surface. The display device may be any product or component having a display function, such as a mobile phone, a tablet computer, a television, a monitor, a laptop computer, a digital photo frame, a navigator, etc. Specific structures of the display device may refer to the embodiments of the above display panel, which will not be repeated here.

For example, in the display device according to the embodiment of the present disclosure, in order to achieve a good display effect, the backlight module is bended to have a same curved shape as the display panel. For example, the backlight module and the display panel with a same curve degree are fixedly connected with each other by engagement components; or, the backlight module and the display panel with the same curve degree are connected with each other by an adhesive; or, the display panel is formed into a curved shape, and then the backlight module and the display panel are fixedly connected with each other by a magnetic force or a frame. Thus, light emitted from the backlight module is uniformly provided to the display panel, so that light leakage is effectively reduced in the case that the display device performs curve surface display.

In order to more clearly explain the fact that the display panel according to the present disclosure effectively reduce the light leakage phenomenon in the case that the display panel performs curve surface display under the mode in which the initial alignment of the liquid crystal molecules is in the horizontal direction, as shown in FIG. 3, two comparative display panels are compared with the display panel according to the embodiment of the present disclosure. In one comparative display panel, the curve degree of the central region of the display panel is same as that of the peripheral region, and such comparative display panel is called as O-shape display panel; in the other comparative display panel, the curve degree of the central region of the display panel is bigger than that of the peripheral region, and such comparative display panel is called as V-shape display panel. The V-shape display panel can effectively reduce the light leakage in the case that the display panel performs curve surface display under the mode in which the initial alignment of the liquid crystal molecules is in a vertical direction. The curve degree of the central region of the display panel according to the embodiment of the present disclosure is smaller than that of the peripheral region, and the display panel according to the embodiment of the disclosure for example is called as U-shape display panel for simplicity; the display panel according to the embodiment of the disclosure effectively reduces light leakage in the case that the display panel performs curve surface display under the mode in which the initial alignment of the liquid crystal molecules is in the horizontal direction.

The above three types of display panels perform curve surface display under the ADS mode, and test data are obtained through substrate stress simulation and liquid crystal optical simulation. Through the test data, it can be proved that the display panel according to the embodiment of the present disclosure effectively reduces the light leakage in the case that the display panel performs the curve surface display under the ADS mode. For example, the display panel for performing the curve surface display comprises: an upper substrate, a lower substrate, an upper polarizer provided on the upper substrate, a lower polarizer provided below the lower substrate, and liquid crystal molecules filled between the upper substrate and lower substrate. For example, the upper and lower substrates have a thickness of 0.5 mm, the lower polarizer provided below the lower substrate has a horizontal polarization direction, the upper polarizer provided on the upper substrate has a vertical polarization direction, and a size of the display panel is 55 inches. For example, a radius of curvature of the O-shaped display panel is 7000 mm; a radius of curvature of the central region of the V-shaped display panel is 7000 mm and a radius of curvature of the peripheral regions of the V-shaped display panel is 15000 mm; a radius of curvature of the central region of the U-shaped display panel is 15000 mm and a radius of curvature of the peripheral regions of the U-shaped display panel is 7000 mm. For example, the upper and lower substrates of the display panel are made of glasses, and a stress constant of the glasses is 3.5×10⁻¹¹Pa⁻¹; and a liquid crystal optical retardation value is 340 nm.

The above three types of display panels perform curve surface display under the ADS mode, test data are obtained at the time of displaying black, and the test data are shown as follows.

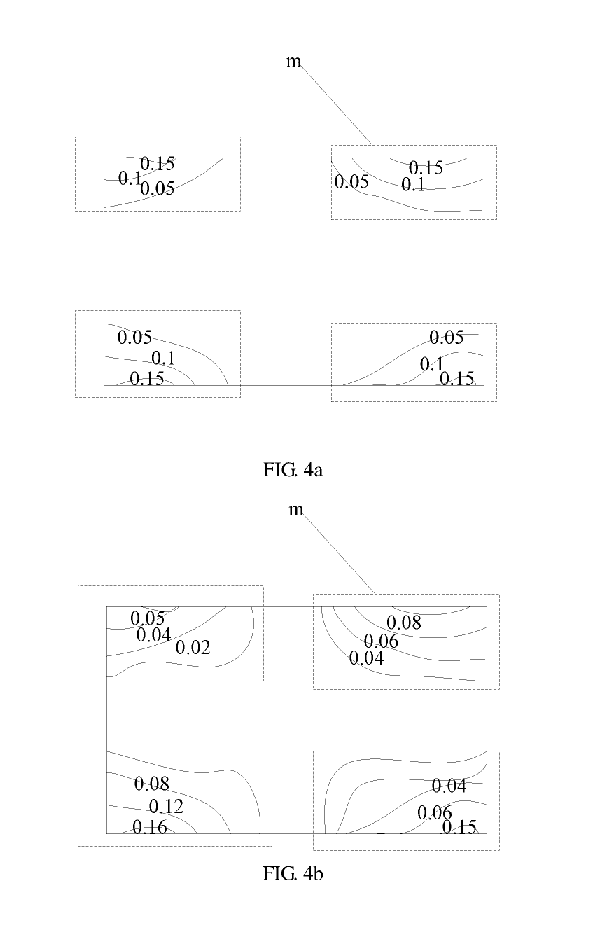

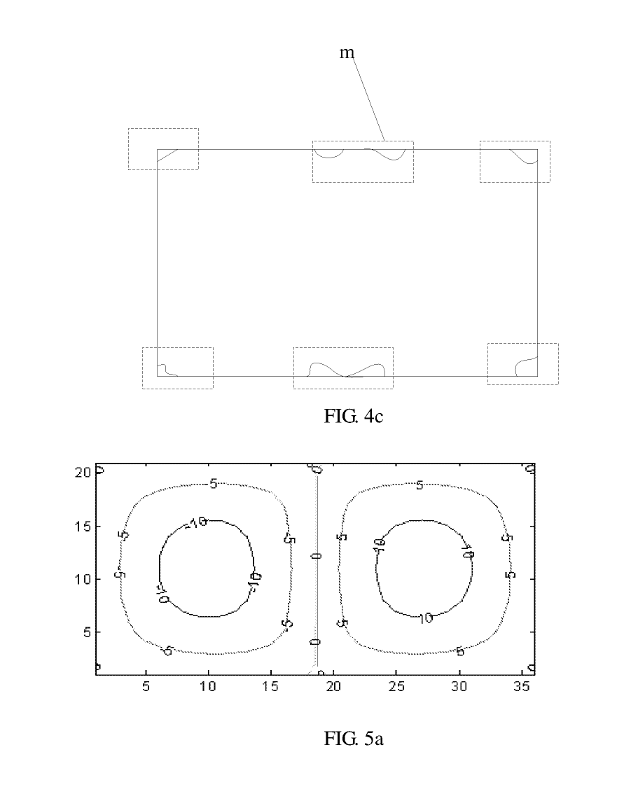

A simulation result of the V-shaped display panel at the time of curve surface display is shown in FIG. 4a, a simulation result of the O-shaped display panel at the time of curve surface display is shown in FIG. 4b, and a simulation result of the U-shaped display panel at the time of curve surface display is shown in FIG. 4c. In FIG. 4a to FIG. 4c, a region m marked by dotted boxes is a light leakage region of the display panel at the time of curve surface display, and a numerical value in the light leakage region m represents luminance of leaked light. It can be seen from FIG. 4a to FIG. 4c that, in the case that the V-shaped display panel performs curve surface display under the ADS mode, light leakage phenomenon occurs in large regions of four corners of the display panel; in the case that the O-shaped display panel performs curve surface display under the ADS mode, compared with the V-shaped display panel, light leakage phenomenon occurs in much larger regions of four corners of the display panel; however, in the case that the U-shaped display panel performs curve surface display under the ADS mode, light leakage phenomenon occurs in smaller regions of four corners of the display panel. Therefore, the display panel according to the embodiment of the present disclosure effectively reduces light leakage in the case that it performs curve surface display under the ADS mode.

In order to achieve curve surface display of the display panel, the display panel is formed into a curved shape, which leads to black matrix deviation in the display panel, and further leads to undesirable phenomena such as color cast and uneven brightness in images displayed by the display panel. Compared with the V-shaped display panel and the O-shaped display panel, the display panel according to the embodiment of the present disclosure reduces the black matrix deviation in the case that it performs curve surface display, and thus the phenomena such as color cast and uneven brightness of the displayed images is reduced as well.

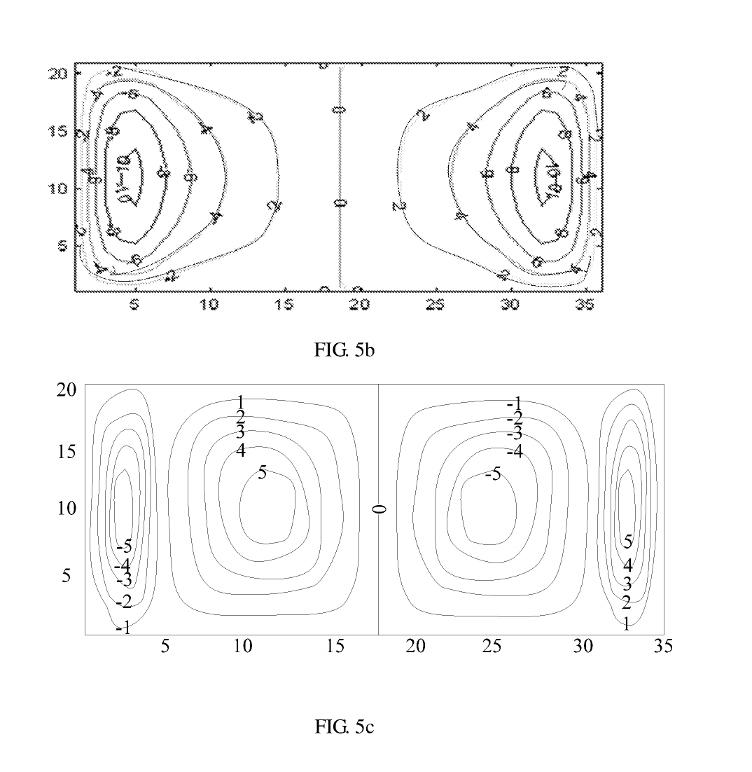

The above three types of display panels of the V-shaped, the O-shaped, and the U-shaped are employed to implement curve surface display; and in the case that the three types of display panels perform curve surface display, simulation results of black matrix deviation are shown as follows. In the case that the V-shaped display panel performs curve surface display, the simulation result of black matrix deviation is shown in FIG. 5a; in the case that the O-shaped display panel performs curve surface display, the simulation result of black matrix deviation is shown as FIG. 5b; in the case that the U-shaped display panel performs curve surface display, the simulation result of black matrix deviation is shown in FIG. 5c. In FIG. 5a to FIG. 5c, numerical values on right side of the figures is a range of black matrix deviation, a numerical value in a box region is the black matrix derivation value in corresponding region, a numerical value with “−” represents a derivation value that the black matrix derivates to the left in the corresponding region, and a numerical value without “−” represents a derivation value that the black matrix derivates to the right in the corresponding region. It can be seen from FIG. 5a to FIG. 5c that, in the case that the V-shaped display panel performs curve surface display, the range of the black matrix deviation of the display panel is −10 to 10, which means a large black matrix deviation, and thus leads to serious phenomena such as color cast and uneven brightness of the displayed images; in the case that the O-shaped display panel performs curve surface display, the range of the black matrix deviation of the display panel is −10 to 10, and black matrix derivation regions are large on two opposite left and right ends of the display panel, which easily leads to phenomena such as color cast and uneven brightness of the displayed images; however, in the case that the U-shaped display panel performs curve surface display, the range of the black matrix deviation of the display panel is −5 to 5. Compared with the V-shaped display panel and the O-shaped display panel, in the case that the U-shaped display panel according to the embodiment of the present disclosure performs curve surface display, black matrix deviation is small, and thus the phenomena such as color cast and uneven brightness of the displayed images at the time of curve surface display is effectively reduced.

The foregoing embodiments merely are exemplary embodiments of the disclosure, and not intended to define the scope of the disclosure, and the scope of the disclosure is determined by the appended claims.

The present application claims priority of Chinese Patent Application No. 201510041421.3 filed on Jan. 27, 2015, the disclosure of which is incorporated herein by reference in its entirety as part of the present application.

1. A display panel, comprising a central region and peripheral regions, wherein,
the peripheral regions are provided at two opposite ends of the display panel and have a first curvature;
the central region is provided between the two opposite ends of the display panel and has a second curvature; and
the second curvature of the central region is smaller than the first curvature of the peripheral regions.

2. The display panel according to claim 1, wherein the two opposite ends of the display panel respectively bend toward a front side of the display panel with respect to a center of the display panel.

3. The display panel according to claim 2, wherein the two opposite ends are two opposite ends respectively provided on left and right sides of the display panel.

4. The display panel according to claim 1, wherein the peripheral regions are respectively provided on left and right sides of the central region and are symmetrical to each other.

5. The display panel according to claim 1, wherein the peripheral regions have a same first curvature.

6. The display panel according to claim 1, wherein a radius of curvature of the peripheral region is within a range of 1000 mm-7000 mm.

7. The display panel according to claim 1, wherein a radius of curvature of the central region is within a range of 7000 mm-15000 mm.

8. A display device, comprising: a display panel and a backlight module disposed on a side of the display panel away from a display surface, wherein
the display panel comprises a central region and peripheral regions;
the peripheral regions are provided at two opposite ends of the display panel and have a first curvature;
the central region is provided between the two opposite ends of the display panel and has a second curvature; and
the second curvature of the central region is smaller than the first curvature of the peripheral regions.

9. The display device according to claim 8, wherein the backlight module has a same curved shape as the display panel.

10. The display device according to claim 8, wherein,
the display panel and the backlight module are fixedly connected with each other by engagement components; or,
the display panel and the backlight module are connected with each other by an adhesive; or,
the display panel and the backlight module are fixedly connected with each other by a magnetic force or a frame.

11. The display device according to claim 9, wherein,
the display panel and the backlight module are fixedly connected with each other by engagement components; or,
the display panel and the backlight module are connected with each other by an adhesive; or,
the display panel and the backlight module are fixedly connected with each other by a magnetic force or a frame.

12. The display device according to claim 8, wherein the two opposite ends of the display panel respectively bend toward a front side of the display panel with respect to a center of the display panel.

13. The display device according to claim 12, wherein the two opposite ends are two opposite ends respectively provided on left and right sides of the display panel.

14. The display device according to claim 8, wherein the peripheral regions are respectively provided on left and right sides of the central region and are symmetrical to each other.

15. The display device according to claim 8, wherein the peripheral regions have a same first curvature.

16. The display device according to claim 8, wherein a radius of curvature of the peripheral region is within a range of 1000 mm-7000 mm.

17. The display device according to claim 8, wherein a radius of curvature of the central region is within a range of 7000 mm-15000 mm.
